(19) United States
(12) Patent Application Publication
(10) Pub. No.: US 2014/0335396 A1
(43) Pub. Date: Nov. 13, 2014

(54) Microporous Membrane

(71) Applicant: ASAHI KASEI E-MATERIALS CORPORATION, Tokyo (JP)

(72) Inventors: Takeshi Onizawa, Tokyo (JP); Hisashi Takeda, Tokyo (JP); Keitaro Ameyama, Tokyo (JP)

(73) Assignee: ASAHI KASEI E-MATERIALS CORPORATION, Tokyo (JP)

(21) Appl. No.: 14/346,980

(22) PCT Filed: Sep. 26, 2012
(86) PCT No.: PCT/JP2012/074738

§ 371 Date: Mar. 25, 2014

(30) Foreign Application Priority Data
Sep. 26, 2011 (JP) 2011-209561

(51) Int. Cl. H01M 2/16; H01M 2/14

(52) U.S. Cl. CPC H01M 2/1686; H01M 2/145
USPC 429/145; 427/58; 156/247

(57) ABSTRACT

A microporous membrane having a polyolefin microporous membrane and a surfactant adhering to the polyolefin microporous membrane, wherein the surfactant includes a surfactant (A) having a solubility in 100 g of water of 5 g or more and a surfactant (B) having a solubility in 100 g of water of less than 0.1 g, the surfactants (A) and (B) are adhered in an amount of 1 to 40% by mass in total based on 100% by mass of the polyolefin microporous membrane, and the polyolefin microporous membrane has a tortuosity factor of more than 2.0.

### TECHNICAL FIELD

The present invention relates to a microporous membrane, a battery separator, an aqueous electrolyte battery, and a method for producing the microporous membrane.

### BACKGROUND ART

Since polyolefin microporous membranes exhibit excellent electrical insulating properties and ion permeability, they are widely utilized as a separator in batteries, capacitors and the like. Especially with the increasing number of functions and reduced weight of mobile devices, high output density and high volume density lithium ion secondary batteries in which a polyolefin microporous membrane is used as a separator have become widespread as a power source for such mobile devices in recent years.

On the other hand, although polyethylene and polypropylene are mainly used for a polyolefin microporous membrane, these polymers generally exhibit hydrophobic properties, and thus cannot be used as is in aqueous electrolyte batteries such as nickel-metal hydride batteries, nickel-cadmium batteries, and zinc-air batteries. Consequently, a microporous membrane formed from a hydrophilic polymer or a microporous membrane formed from a hydrophobic polymer that has been subjected to a hydrophilization treatment is usually used for the aqueous electrolyte battery separator.

As an example a hydrophilization treatment of a microporous membrane formed from a hydrophobic polymer, Patent Literature 1 proposes that the interior surfaces of the pores and the membrane surface of a polyolefin microporous membrane is treated with a surfactant under specific conditions thereby to obtain a separator that has excellent wettability and liquid retention for water and an organic electrolyte solution.

Further, Patent Literature 2 reports that liquid retention is improved by uniformly adhering a hydrophilic surfactant to the polyolefin microporous membrane, and that when such a membrane is used as an alkaline zinc battery separator, precipitation of zinc on the negative electrode surface is suppressed and the battery properties are improved.

### CITATION LIST

### Patent Literature

Patent Literature 1: Japanese Patent No. 3072163
Patent Literature 2: Japanese Patent No. 2755634

### SUMMARY OF INVENTION

### Technical Problem

However, there is room to improve the microporous membranes described in Patent Literatures 1 and 2 from the perspective of balance between initial hydrophilic properties and durable hydrophilic properties. Further, those microporous membranes cannot exhibit sufficient battery properties when used as an aqueous electrolyte battery separator.

It is an object of the present invention to provide a microporous membrane that has an excellent balance between initial hydrophilic properties and durable hydrophilic properties.

### Solution to Problem

As a result of diligent research into resolving the above-described problems, the present inventors found that a microporous membrane obtained by adhering both a surfactant that is soluble in water and a surfactant that is insoluble in water to a polyolefin microporous membrane that has a specific tortuosity factor can achieve the above-described object, thereby completing the present invention.

Namely, the present invention is as follows.

[1] A microporous membrane comprising a polyolefin microporous membrane and a surfactant adhering to the polyolefin microporous membrane, wherein

the surfactant comprises a surfactant (A) having a solubility in 100 g of water of 5 g or more and a surfactant (B) having a solubility in 100 g of water of less than 0.1 g,

the surfactants (A) and (B) are adhered in an amount of 1 to 40% by mass in total based on 100% by mass of the polyolefin microporous membrane, and

the polyolefin microporous membrane has a tortuosity factor of more than 2.0.

[2] The microporous membrane according to the above [1], wherein the polyolefin microporous membrane has an average pore size of 0.06 to 0.10 μm.
[3] The microporous membrane according to the above [1] or [2], wherein a ratio (MD/TD) between an MD tensile strength and a TD tensile strength of the polyolefin microporous membrane is 0.3 to 3.0.
[4] The microporous membrane according to any of the above [1] to [3], wherein a mass ratio (A/B) between the surfactant (A) and the surfactant (B) is 0.3 to 3.0.
[5] A battery separator wherein the microporous membrane according to any of the above [1] to [4] is used.
[6] An aqueous electrolyte battery comprising the battery separator according to the above [5], a positive electrode, a negative electrode, and an electrolyte.
[7] A method for producing the microporous membrane according to any of the above [1] to [4], comprising the steps of:

coating a surfactant solution on at least one face of a polyolefin microporous membrane with a gravure roll; and

removing a solvent from the surfactant solution coated on the polyolefin microporous membrane by drying.

[8] A method for producing the microporous membrane according to any of the above [1] to [4], comprising the steps of:

laminating a non-porous polymer film on one face of a polyolefin microporous membrane;

coating a surfactant solution on an opposite face to a laminated face of the polyolefin microporous membrane on which the non-porous polymer film has been laminated;

removing a solvent from the surfactant solution coated on the polyolefin microporous membrane by drying; and

peeling the non-porous polymer film from the polyolefin microporous membrane.

[9] A microporous membrane in which a surfactant is adhered to a polyolefin microporous membrane, wherein a contact angle with respect to water after dipping in water for 24 hours and then drying is 30° or less.

### Advantageous Effects of the Invention

The microporous membrane according to the present invention has an excellent balance between initial hydrophilic properties and durable hydrophilic properties and is suitable as an aqueous electrolyte battery separator.

### DESCRIPTION OF EMBODIMENT

A mode for carrying out the present invention (hereinafter abbreviated as “embodiment”) will now be described in more detail. However, the present invention is not limited to the following embodiment. Various modifications may also be made within the scope of the present invention.

In the present specification, the polyolefin microporous membrane before a surfactant is adhered is sometimes referred to as “base membrane,” and the microporous membrane after a surfactant has been adhered is sometimes referred to as “hydrophilic membrane.”

The hydrophilic membrane according to the present embodiment is characterized in that it is a membrane wherein 1 to 40% by mass of a surfactant is adhered to 100% by mass of a base membrane having continuous pores in a membrane thickness direction and a tortuosity factor of more than 2.0, and that the surfactant is formed from a mixture of at least two or more surfactants, a surfactant (A) soluble in water and a surfactant (B) insoluble in water.

In the present specification, regarding the determination whether a surfactant is soluble or insoluble in water, when a solubility of a surfactant in water at 25° C. is 5 g or more based on 100 g of water, the surfactant is defined as soluble, and when a solubility of a surfactant in water at 25° C. is less than 0.1 g based on 100 g of water, the surfactant is defined as insoluble. As long as the above-described surfactant adhered to a base membrane includes at least a surfactant (A) soluble in water and a surfactant (B) insoluble in water, the above-described surfactant adhered to a base membrane may also include another surfactant (i.e., a surfactant having a solubility in water of 0.1 g based on 100 g of water to 5 g based on 100 g of water.)

The hydrophilic membrane according to the present embodiment has an excellent balance between initial hydrophilic properties and durable hydrophilic properties and can be preferably used as an aqueous electrolyte battery separator. Especially, this hydrophilic membrane has an excellent battery capacity and storage properties when used as a zinc-air battery separator.

Technique for performing a hydrophilization treatment by adhering a surfactant to a hydrophobic base membrane has been investigated in the past, such as in Patent Literature 1. However, a hydrophilic membrane produced by this method suffers from the drawback in terms of durable hydrophilic properties that the hydrophilic properties are gradually lost since a part of the adhered surfactant is washed away by water.

Although durable hydrophilic properties can be improved by using a surfactant having a low solubility in water, when a surfactant having a low solubility in water is used, the initial hydrophilic properties are insufficient. There have been no hydrophilic membranes that resolve this tradeoff between initial hydrophilic properties and durable hydrophilic properties yet.

However, from the results of diligent research, the present inventors found that a hydrophilic membrane having excellent initial hydrophilic properties and durable hydrophilic properties is realized by adhering two or more surfactants having a different solubility in water to a base membrane having a tortuosity factor in a specific range. Further, the present inventors also found that such a hydrophilic membrane has an excellent battery capacity and storage properties when used as a zinc-air battery separator.

The base membrane used in the hydrophilic membrane according to the present embodiment will now be described.

It is preferred that the tortuosity factor of the base membrane is more than 2.0 and 3.0 or less, and more preferred is 2.2 to 2.8. According to research by the present inventors, it was learned that when the tortuosity factor of the base membrane is more than 2.0, the surfactant adhered to the base membrane is less susceptible to flowing out from the pores inside the microporous membrane onto the outer surface, and as a result, the durable hydrophilic properties can be improved without harming initial hydrophilic properties. Further, from the perspective of ion permeability when used as a battery separator, it is preferred that the tortuosity factor is 3.0 or less.

The tortuosity factor of the base membrane can be determined according to the method described in the Examples.

The tortuosity factor of the base membrane can be regulated based on the ratio between the raw material polymer and plasticizer, as well as the heat setting temperature, stretching ratio and the like after the plasticizer is extracted. Specifically, the tortuosity factor can be increased by increasing the polymer/plasticizer ratio, increasing the stretching temperature after the plasticizer is extracted, or decreasing the stretching ratio.

The average pore size of the base membrane is preferably 0.06 to 0.10 μm, and more preferably 0.06 to 0.08 μm. When the average pore size is 0.06 μm or more, when used as a battery separator, the ion permeability tends to be good and electrical resistance tends to be lower. When the average pore size is 0.10 μm or less, the adhered surfactant tends to be less susceptible to flowing out due to diffusion caused by the concentration gradient in water and durable hydrophilic properties tend to be excellent.

A ratio “MD strength/TD strength” between the MD tensile strength (hereinafter abbreviated as “MD strength”) and the TD tensile strength (hereinafter abbreviated as “TD strength”) of the base membrane is preferably 0.3 to 3.0, and more preferably 0.5 to 2.0. When the MD strength/TD strength ratio is in this range, namely, when the anisotropy of the polymer orientation of the membrane is suitable, the membrane is less susceptible to tearing and breaking during winding, and thus such a ratio is preferable.

Further, although the detailed reasons are not clear, it has been found that a hydrophilic membrane having a base membrane MD strength/TD strength ratio in this range has excellent durable hydrophilic properties. This is thought to be because of a pore structure from which the surfactant does not easily flow out, the pore structure being formed by slight thermal contraction of the membrane in two axial directions during a drying process carried out after coating the surfactant aqueous solution. Here, MD refers to the machine direction in which the membrane progresses (is extruded) during membrane production, and TD refers to the direction orthogonal to the machine direction.

From a strength perspective, it is preferred that the base membrane has a thickness of 5 μm or more, and from the perspective of increasing the battery capacity, the thickness is preferably 50 μm or less. A more preferred membrane thickness is 10 to 30 μm.

From a permeability perspective, it is preferred that the base membrane has a porosity of 30% or more, and from the perspectives of strength, winding properties, and durable hydrophilic properties, 50% or less is preferred. A more preferred porosity is 35 to 45%.

From a safety perspective, it is preferred that the base membrane has an air permeability of 10 sec/100 cc or more, and from the perspective of ion permeability, 500 sec/100 cc or less is preferred. The air permeability is more preferably 50 to 400 sec/100 cc.

From the perspective of suppressing the infiltration of contaminants into the battery and punctures caused by dendrites, it is preferred that the base membrane has a puncture strength of 3.0 N or more, and from the perspective of ease of winding in the battery production process, the puncture strength is preferably 8.0 N or less. More preferred is a puncture strength of 3.5 to 7.0 N.

It is preferred that the base membrane has an MD strength of 100 to 200 MPa and a TD strength of 50 to 200 MPa, and more preferably an MD strength of 120 to 180 MPa and a TD strength of 100 to 150 MPa.

The polyolefin forming the base membrane is a polymer that includes an olefinic hydrocarbon as a monomer component. Although the polyolefin also includes copolymers of an olefinic hydrocarbon and a monomer other than an olefin, it is preferred that the copolymerization ratio of the olefinic hydrocarbon unit is 95% by mass or more, more preferably 97% by mass or more, and even more preferably 99% by mass or more.

Specific examples of the polyolefin include homopolymers of ethylene, propylene, and the like, and copolymers obtained by polymerizing at least two monomers selected from the group consisting of ethylene, propylene, 1-butene, 4-methyl-1-pentene, 1-hexene, 1-octene, and norbornene. These polyolefins can be used singly or as a mixture of two or more thereof.

When the base membrane is a stretched film, it is preferred to use a mixture as the polyolefin forming the base membrane, because control of the heat treatment temperature during stretching is easier.

Especially, for example, a mixture formed by mixing an ultrahigh molecular weight polyolefin having a viscosity average molecular weight (hereinafter sometimes abbreviated as “Mv”) of 500,000 or more and a polyolefin having an Mv of less than 500,000 is more preferred from the perspective that it is easy to confer isotropy to the strength of the base membrane based on a suitable molecular weight distribution of these components. In the present specification, Mv is measured based on ASTM-D4020.

Further, it is also preferred that the mixed polyethylene is a high-density homopolymer from the perspective that heat setting can be carried out at a higher temperature while suppressing blocking of the pores in the base membrane, and the perspective that the ratio of thermal contraction is decreased.

In addition, it is preferred that the Mv of the whole base membrane (the polymer materials forming the base membrane) is 100,000 to 1,200,000, and more preferred is 300,000 to 800,000. The Mv is preferably 100,000 or more, because tearing resistance tends to be exhibited when the battery gives off heat due to short-circuiting caused by contaminants or the like. The Mv is preferably 1,200,000 or less, because molecular orientation in the MD during the extrusion process tends to be suppressed, thereby to tend to exhibit isotropy.

Still further, as the polyolefin, a mixture obtained by additionally mixing polypropylene to the polyethylene mixture is especially preferred. Such a mixture can provide a base membrane that has suitable thermal contraction resistance.

In this case, the amount of polypropylene mixed based on all (the total amount) of the polyolefin is preferably 1 to 80% by mass, more preferably 2 to 50% by mass, even more preferably 3 to 20% by mass, and especially preferably 5 to 10% by mass.

Depending on the intended purpose, the base membrane may also include known additives, such as a polymer other than the polyolefin; a metal soap such as calcium stearate and zinc stearate; an ultraviolet absorber; a light stabilizer; an antistatic agent; an anti-fogging agent; and a coloring pigment.

Next, a specific example of the method for producing the base membrane will be described. It is noted that as long as the resulting base membrane satisfies the above-described requirements for the various properties, the method for producing a base membrane is not limited. Even in the specific example of the production method described below, no restrictions are placed on the type of solvent, the extrusion method, the stretching method, the extraction method, the pore-opening method, the heat setting/heat treatment method, and the like.

A specific example of the method for producing the base membrane includes the following processes (a) to (f).

(a) A kneading process for kneading a polyolefin, a plasticizer, and optionally inorganic materials.
(b) An extrusion process for extruding the kneaded product obtained by the kneading process.
(c) A sheet-molding process for molding the extruded product obtained by the extrusion process into a sheet-like form (which may be a monolayer or a laminate) and cooling to solidify.
(d) A stretching process for stretching the sheet-like molded product obtained by the sheet-molding process in one or more axial directions.
(e) An extraction process for extracting the plasticizer and the optional inorganic materials from the stretched film obtained by the stretching process.
(f) A post-treatment process for heating and thermally fixing the extracted stretched film.

The blending ratio of the polyolefin in the kneading process (a) is, based on the total mass of the polyolefin, the plasticizer, and the optional inorganic materials, preferably 1 to 60% by mass, and more preferably 10 to 40% by mass.

As the plasticizer, an organic compound that can form a uniform solution with the polyolefin at a temperature equal to or less than its boiling point is preferred. Specific examples of the plasticizer include decalin, xylene, dioctyl phthalate, dibutyl phthalate, stearyl alcohol, oleyl alcohol, decyl alcohol, nonyl alcohol, diphenyl ether, n-decane, n-dodecane, and paraffin oil (liquid paraffin). Among these, paraffin oil and dioctyl phthalate are preferred.

Although the blending ratio of the plasticizer is not especially limited, from the perspective of obtaining a base membrane with a suitable tortuosity factor, pore size, and porosity, based on the total mass of the polyolefin, the plasticizer, and the optional inorganic materials, the blending ratio of the plasticizer is preferably 20% by mass or more and 90% by mass or less, more preferably 60% by mass or more and 80% by mass or less, and even more preferably 65% by mass or more and 70% by mass or less.

Examples of the inorganic materials include oxide-based ceramics, such as alumina, silica (silicon oxide), titania, zirconia, magnesia, ceria, yttria, zinc oxide, and iron oxide; nitride-based ceramics, such as silicon nitride, titanium nitride, and boron nitride; ceramics such as silicon carbide, calcium carbonate, aluminum sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, diatomaceous earth, and silica sand; and glass fiber. These are used singly or in combinations of two or more thereof. Among them, from the perspective of electrochemical stability, silica, alumina, and titania are preferred.

The blending ratio of the inorganic materials is, based on the total mass of the polyolefin and the inorganic materials, from the perspective of obtaining good isolation properties, preferably 5% by mass or more and more preferably 10% by mass or more, and from the perspective of ensuring a high strength, preferably 99% by mass or less and more preferably 95% by mass or less.

The kneading method in the kneading process (a) is not limited. For example, this process may be carried out by first pre-mixing a part or all of the raw materials as necessary using a Henschel mixer, a ribbon blender, a tumbler blender, or the like, and then melt-kneading all of the raw materials with a screw extruder, such as a single screw extruder or a twin screw extruder, a kneader, a mixer, and the like.

Before the melt-kneading, it is preferred to mix an antioxidant to the polyolefin of the raw material at a predetermined concentration, purge the air around the mixture with a nitrogen atmosphere, and carry out the melt-kneading in a state in which the nitrogen atmosphere is maintained. The temperature during the melt-kneading is preferably 160° C. or more, and more preferably 180° C. or more. Further, this temperature is preferably less than 300° C.

In the extruding process (b), the kneaded product obtained by the above-described kneading process (a) is extruded by an extruder, such as a T-die or an annular die. At this stage, a monolayer or a laminate may be extruded. The various conditions during the extrusion can be set the same as conditions that are conventionally employed.

Next, in the sheet-molding process (c), the extruded product obtained by the above-described respective processes (a) and (b) is molded into a sheet-like form and cooled to solidify. The sheet-like molded product obtained by the sheet-molding may be a monolayer or a laminate. Examples of the method for forming the sheet include solidifying the extruded product by compressed cooling. Examples of the cooling method include bringing the extruded product into direct contact with a cooling medium, such as cold air or cold water, or bringing the extruded product into contact with a roll or a pressing machine that has been cooled with a cooling medium. The method in which the extruded product is brought into contact with a roll or a pressing machine that has been cooled with a cooling medium is preferred because membrane thickness control is excellent. The cooling temperature in this case is not especially limited as long as the extruded product solidifies. However, from the perspective of stability during sheet molding, the temperature is preferably 60° C. or more, and more preferably 80° C. or more.

Next, in the stretching process (d), the sheet-like molded product obtained by the sheet-molding process is stretched in one or more axial directions. Examples of the method for stretching the sheet-like molded product include MD monoaxial stretching with a roll stretching machine, TD monoaxial stretching with a tenter, sequential biaxial stretching with a roll stretching machine and a tenter or with a combination of a plurality of tenters, and simultaneous biaxial stretching with a simultaneous biaxial tenter or an inflation molding machine. From the perspective of obtaining a base membrane with higher isotropy, simultaneous biaxial stretching is preferred. The magnification of total area (MD×TD) by the stretching is, from the perspective of a balance among thickness uniformity, tensile strength, porosity, and average pore size of the base membrane, preferably a factor of 8 or more, more preferably a factor of 15 or more, and even more preferably a factor of 30 or more. Especially, when the magnification is a factor of 30 or more, a high-strength separator tends to be obtained.

In the extraction process (e), the plasticizer and the optional inorganic materials are extracted from the stretched film obtained by the stretching process (d). Examples of the extraction process include dipping the stretched film in an extraction solvent, or, bringing the stretched film into contact with a mist, such as a shower, of an extraction solvent. It is desirable that the extraction solvent is a poor solvent for the polyolefin, and a good solvent for the plasticizer and the inorganic materials, and has a boiling point that is lower than the melting point of the polyolefin. Examples of such an extraction solvent include hydrocarbons such as n-hexane and cyclohexane; halogenated hydrocarbons such as methylene chloride, 1,1,1-trichloroethane, and a fluorocarbon compound; alcohols such as ethanol and isopropanol; ketones such as acetone and 2-butanone; and alkaline water. These extraction solvents can be used singly or in combination of two or more thereof.

Moreover, the plasticizer and the optional inorganic materials may be extracted from the sheet-like molded product before the stretching process (d). Further, all or a part of the inorganic materials may be extracted in any of the processes, and allowed to remain in the separator. In addition, the extraction order, method, and number of times are not especially limited. Still further, if necessary, the inorganic materials do not have to be extracted.

In the post-treatment process f), the extracted stretched film is further stretched and relaxed while heating at a predetermined temperature thereby to thermally fix. Consequently, a microporous membrane is obtained that is made of a polyolefin as a raw material and can also be used as the base membrane. Examples of the heat treatment method performed at this time include a thermal fixing method that uses a tenter or a roll stretching machine to perform stretching and relaxation operations. The relaxation operation is a contraction operation performed at a predetermined relaxation ratio in the MD and/or TD of the membrane. The relaxation ratio is a value obtained by dividing the MD dimension of the membrane after the relaxation operation by the MD dimension of the membrane before the operation, a value obtained by dividing the TD dimension of the membrane after the relaxation operation by the TD dimension of the membrane before the operation, or when relaxation operation is performed in both directions of the MD and TD, a value obtained by multiplying the MD relaxation ratio of the membrane by the TD relaxation ratio of the membrane.

To obtain a base membrane having a suitable tortuosity factor, pore size, and porosity, the above-described predetermined temperature (heat setting temperature) is preferably 100° C. or more and less than 140° C. To achieve a suitable tortuosity factor, pore size, and porosity, the stretching ratio during the heat setting is preferably a factor of 1.0 to 2.0. The higher the heat setting temperature and the lower the stretching ratio, the higher the tortuosity factor that can be designed. Specifically, a heat setting temperature of 125 to 135° C. and a stretching ratio during heat setting of 1.3 to 1.8 is especially preferred. Further, from the perspective of the ratio of thermal contraction, the relaxation ratio during heat setting is preferably a factor of 0.9 or less. From the perspective of preventing the occurrence of wrinkles, and the perspective of porosity and permeability, the relaxation ratio during heat setting is preferably a factor of 0.6 or more. The relaxation operation can be carried out in both the MD and TD directions. However, the relaxation operation can also be carried out in just either the MD or the TD direction. Consequently, the ratio of thermal contraction can be decreased not only in the operation direction, but also in the direction orthogonal to the operation.

Next, the method for hydrophilizing the base membrane will be described. Common known methods for hydrophilizing a polyolefin microporous membrane include coating and adhering a surfactant, introducing a hydrophilic group by graft polymerization, modifying the surface by a corona treatment, and the like. However, in the present embodiment, from the perspective of process simplicity, hydrophilization is carried out by adhering a surfactant to the base membrane. Further, although it is sufficient when the surfactant is adhered to at least one face of the base membrane and to the interior of the pores running through to that face, the surfactant may also be adhered to both faces.

From the perspective of a balance between initial hydrophilic properties and durable hydrophilic properties, the surfactant used in the hydrophilic membrane according to the present embodiment is formed from a mixture of at least two or more surfactants, a surfactant (A) soluble in water and a surfactant (B) insoluble in water.

The initial hydrophilic properties represent the wettability of the hydrophilic membrane with respect to water, and the durable hydrophilic properties represent how much the wettability with respect to water is retained after the hydrophilic membrane is dipped in water for a fixed period.

When a surfactant having a high solubility in water is used alone, although the initial hydrophilic properties are high due to a high affinity to water, the durable hydrophilic properties are low because the surfactant tends to elute into the water. Conversely, when a surfactant having a low solubility in water is used alone, although the durable hydrophilic properties are high because the surfactant does not easily elute into the water, the initial hydrophilic properties are low due to a low affinity to water. Further, when a surfactant having a medium solubility in water is used alone, both the initial hydrophilic properties and the durable hydrophilic properties are low.

In contrast, it has been found that by combining two or more surfactants that have different degrees of solubility in water, both initial hydrophilic properties and durable hydrophilic properties can be obtained.

Examples of the type of surfactant include nonionic surfactants, cationic surfactants, anionic surfactants, and amphoteric surfactants. However, for using the hydrophilic membrane according to the present embodiment as an aqueous electrolyte battery separator, a nonionic surfactant is especially preferred because such a surfactant is less susceptible to electrochemical effects and is hardly decomposed by acids or alkalis. Specific examples of the surfactant include polyoxyethylene alkyl ether, polyoxyethylene alkyl phenyl ether, polyoxyethylene mono-fatty acid esters, polyoxyethylene-modified polydimethylsiloxane, and alkyl imidazoline.

Although the surfactant (A), which has a high solubility in water, is not especially limited, from the perspective of a balance between initial hydrophilic properties and durable hydrophilic properties, less susceptibility to electrochemical effects, and acid and alkali resistance, polyoxyethylene-modified polydimethylsiloxane and polyoxyethylene alkyl ether are preferred. Although the surfactant (B), which has a low solubility in water, is not especially limited, from the perspective of a balance between initial hydrophilic properties and durable hydrophilic properties, less susceptibility to electrochemical effects, and acid and alkali resistance, alkyl imidazoline is preferred.

The mass ratio between the surfactant (A) and the surfactant (B) adhered to the base membrane is not limited, and may be appropriately determined based on the type of surfactants (A) and (B) to be specifically used by testing in advance and the like. However, when this mass ratio (A/B) is 0.3 to 3.0, the balance between initial hydrophilic properties and durable hydrophilic properties tends to be better. More preferably, the mass ratio (A/B) is 0.5 to 2.0, and even more preferably is 0.66 to 1.5.

Although the method for adhering the surfactant to the base membrane is not especially limited, from the perspective of process simplicity, a method in which the surfactant solution is coated on the base membrane and then the solvent is removed by drying is preferred.

In this case, examples of the surfactant solution solvent include water, methanol, ethanol, isopropanol, and acetone, which can be used singly or as a mixture. However, from the perspectives of solubility when adjusting the surfactant solution and permeability when coating the surfactant solution on the base membrane, a mixture of water and ethanol is especially preferred. The ethanol concentration in the mixture of water and ethanol is preferably 20 to 60%, and more preferably 30 to 50%.

Although the surfactant concentration of the surfactant solution (the total surfactant concentration) is not especially limited, to adhere a suitable amount of surfactant to the base membrane, the concentration is preferably 5 to 60% by mass, and more preferably 10 to 50% by mass.

Examples of the method for coating the surfactant solution include a gravure coater method, a small-diameter gravure coater method, a reverse roll coater method, a transfer roll coater method, a kiss coater method, a dip coater method, a knife coater method, an air doctor coater method, a blade coater method, a wire bar coater method, a rod coater method, a squeeze coater method, a cast coater method, a die coater method, a screen printing method, and a spray coating method. However, from the perspectives of uniformly coating the surfactant solution and of continuously coating while controlling the amount to be adhered, coating with a gravure coater is especially preferred.

The surfactant solution is coated on at least one face of the base membrane.

Examples of the method for removing the solvent from the surfactant solution coated on the base membrane may include, but are not limited to, heat-drying at a temperature not greater than the melting point of the polyolefin, and drying under reduced pressure.

In the case of coating with a gravure coater, to prevent the roll in the coating apparatus from becoming contaminated due to permeating of the surfactant solution as far as the opposite side of the base membrane, prior to coating, the base membrane can be laminated to a non-porous film while simultaneously feeding the non-porous film, then coated and dried, followed by peeling off the non-porous film. A non-porous film is a film that does not have a porous structure. Its material is not especially limited as long as it does not let the surfactant essentially permeate therein. For example, a polymer film can be used.

Next, a microporous membrane according to the present embodiment, which comprises a polyolefin microporous membrane and a surfactant adhered to the polyolefin microporous membrane, and has a contact angle with respect to water of 30° or less after dipping in water for 24 hours and then drying, will be described.

Here, the above-described polyolefin microporous membrane and surfactant may be used for the polyolefin microporous membrane and the surfactant. Further, the microporous membrane can be produced by the same method as described above.

When the microporous membrane has a contact angle with respect to water of 30° or less after dipping in water for 24 hours and then drying, it has an excellent balance between initial hydrophilic properties and durable hydrophilic properties and is suitable as an aqueous electrolyte battery separator. The contact angle with respect to water after dipping in water for 24 hours and then drying is preferably 25° or less, and more preferably 20° or less.

Next, a case in which the hydrophilic membrane according to the present embodiment is used as a battery separator will be described.

Since the hydrophilic membrane according to the present embodiment has both excellent initial hydrophilic properties and durable hydrophilic properties, the hydrophilic membrane is suitable as a battery separator for separating a positive electrode and a negative electrode in a battery that use an aqueous electrolyte.

For example, an aqueous electrolyte battery can be produced by arranging the hydrophilic membrane according to the present embodiment between a positive electrode and a negative electrode, and retaining an aqueous electrolyte.

There are no restrictions on the positive electrode, the negative electrode, or the aqueous electrolyte. Known materials may be used for these parts.

Examples of the positive electrode material include nickel hydroxide, manganese dioxide, graphite, activated carbon, and oxygen. Examples of the negative electrode material include zinc, a hydrogen storage alloy, cadmium hydroxide, graphite, and activated carbon.

Further, examples of the aqueous electrolyte include potassium hydroxide aqueous solution.

### Examples

Next, the present embodiment will now be specifically described with reference to the following Examples and Comparative Examples. However, the present embodiment is not limited to these Examples as long as not exceeding the gist of the present embodiment. Further, the physical properties in the Examples were measured based on the following methods.

### (1) Membrane Thickness (μm)

The membrane thickness was measured at room temperature of 23±2° C. using the micro thickness gauge KBM™, manufactured by Toyo Seiki Seisaku-sho, Ltd. A specimen was cut to a size of 100 mm×100 mm, and then divided into a grid having nine sections. The thickness in the center portion of each section was measured, and the average of the nine values was taken as the membrane thickness.

(2) Air Permeability (s/100 cc)

The air permeability resistance determined using a Gurley permeability tester according to JIS P-8117 was taken as the air permeability.

### (3) Porosity (%)

A specimen was cut to a size of 100 mm×100 mm, and the volume (cm³) and mass (g) thereof were determined. The porosity was then calculated according to the following formula from these values and density (g/cm³) of the polyolefin forming the base membrane of the specimen.

Porosity (%)=(1−(volume/mass)/(polyolefin density))×100

### (4) Puncture Strength (N)

The puncture strength was measured using the handy-type compression tester “KES-G5” ™ (manufactured by Kato Tech Co., Ltd.). A piercing test was carried out with a radius of curvature of the needle tip of 0.5 mm at a piercing rate of 2 mm/s. The maximum piercing load was taken as the puncture strength.

### (5) MD and TD Tensile Strength (MPa), and Tensile Elongation (%)

Tensile strength was measured using samples for MD and TD (size: width 10 mm×length (length in the tension direction) 100 mm) according to JIS K7127 using a tensile tester, Autograph AG-A Model™ manufactured by Shimadzu Corporation. The sample chuck interval was 50 mm. Further, the sample had cellophane tape (product name: N. 29, manufactured by Nitto Denko CS System Corporation) stuck on one face at either end of the sample (25 mm each). In addition, to prevent the sample from slipping during the test, 1 mm-thick fluororubber was stuck to the inner side of the chuck of the tensile tester.

Tensile elongation (%) was determined by dividing the amount of elongation (mm) when braking by the chuck interval (50 mm) and multiplying by 100. The tensile strength (MPa) was determined by dividing the tensile stress applied on the sample when braking by the sample cross-sectional area before the test. The measurement was carried out at a temperature of 23±2° C., a chuck pressure of 0.30 MPa, and a tension rate of 200 mm/minute.

### (6) Average Pore Size (μm) and Tortuosity Factor τ (Dimensionless)

A fluid in a capillary is known to act according to a Knudsen flow when the mean free path of the fluid is greater than the diameter of the capillary, and act according to a Poiseuille flow when smaller. Accordingly, in the present embodiment, the average pore size (μm) and the tortuosity factor T of the base membrane are values determined according to the following formula from an air permeability rate constant R_{gas} (/(m²·sec·Pa)), a water permeability rate constant R_{lig}/(m²·sec·Pa)), the air molecular speed ν (m/sec), the viscosity η of water (Pa·sec), a standard pressure Pₛ (=101325 Pa), porosity c (%), and the membrane thickness L (μm), based on the assumption that the flow of air during the measurement of air permeability of the base membrane follows a Knudsen flow and the flow of water during the measurement of water permeability of the base membrane follows a Poiseuille flow.

d=2ν×(R_{lig}/R_{gas})×(16η/3 Ps)×10⁶

τ=(d×(c/100)×ν/(3L×Pₛ×R_{gas}))^{1/2}

Here, R_{gas} can be determined using the following formula from the air permeability (sec) of the base membrane.

R_{gas}=0.0001/(air permeability×(6.424×10⁻⁴)×(0.01276×101325))

Further, R_{liq} can be determined using the following formula from the water permeability (cm/(cm³·sec·Pa)) of the base membrane.

R_{liq}=water permeability/100

Further, the water permeability can be determined as follows.

A base membrane that has been dipped in alcohol in advance is set in a stainless steel liquid-permeable cell with a diameter of 41 mm. The alcohol in the membrane is washed with water, and water is made to pass through under a pressure difference of about 50,000 Pa. The amount of permeated water per unit time, per unit pressure, and per unit surface area is calculated from the amount of the permeated water (cm³) after 120 seconds had elapsed, and this value is taken as the water permeability.

Further, ν can be determined using the following formula from a gas constant R (=8.314), the absolute temperature T (K), circumference ratio π, and the average molecular weight M of air (=2.896×10⁻² kg/mol).

### ν=((8R×T)/(π×M))^{1/2}

### (7) Solubility in Water (g Per 100 g of Water)

Aliquots, each of which is 0.01 g of a surfactant, were added one by one to 100 g of water at 25° C. while stirring. The total amount of the surfactant added (g) when the solution changed from clear to opaque was taken as the degree of the solubility in water

### (8) Contact Angle (°)

Contact angle was measured with a contact angle measurement apparatus (CA-V type) manufactured by Kyowa Interface Science Co., Ltd. Using the accessorial micro syringe, a droplet of 2 μL of purified water was dropped onto a specimen fixed on a slide glass. The angle formed by the droplet with the specimen 40 seconds later was taken as the contact angle. The measurement was carried out at ordinary temperature under atmospheric pressure. The other conditions were in accordance with the manual.

### (9) Evaluation of Hydrophilic Properties

### (9-1) Evaluation of Initial Hydrophilic Properties

The initial hydrophilic properties were determined as being good when the contact angle of a specimen measured according to the above-described method was 20° or less.

### (9-2) Evaluation of Durable Hydrophilic Properties

A weight was placed on one corner of a specimen cut into a 100 mm×100 mm size, and the specimen was dipped for 24 hours in 10 L of standing water. Then, the specimen was gently taken out, and dried for 15 minutes at 60° C., and the contact angle was then measured. The durable hydrophilic properties were determined as being good when the contact angle was 30° or less.

### (10) Evaluation of Electrical Resistance

A PR44 type (diameter 11.6 mm, height 5.4 mm) zinc-air battery was produced from a perforated positive electrode can, a negative electrode can, diffusion paper, a water repellent membrane, a positive electrode catalyst, a gel-like negative electrode, a current collector, a gasket, and a separator. Kraft paper was used for the diffusion paper. A PTFE membrane was used for the water repellent membrane. A mixture of activated carbon, manganese oxide, graphite, and a PTFE binder was used for the positive electrode catalyst. A mixture of an aqueous 30% KOH solution, polyacrylic acid, and a zinc powder was used for the gel-like negative electrode. A polyamide resin was used for the gasket. The microporous membranes produced in the Examples and Comparative Examples were used for the separator.

The electrical resistance was measured at a 1 kHz alternating current at 25° C. two times. The first measurement was carried out when the battery was produced, and the second time measurement was carried out after discharging at an electrical resistance of 1.5 kΩ to a discharge cutoff voltage of 0.9 V.

### Example 1

### Production of Base Membrane

Forty-five percent by mass of homopolymer polyethylene having an Mv of 700,000, 45% by mass of homopolymer polyethylene having an Mv of 300,000, and 10% by mass of a mixture of homopolypropylene having an Mv of 400,000 and homopolypropylene having an Mv of 150,000 (mass ratio of 4:3, hereinafter referred to as “PP”) were dry-blended using a tumbler blender. To 99% by mass of the obtained polyolefin mixture, 1% by mass of pentaerythrityl-tetrakis-[3-(3,5-di-t-butyl-4-hydroxyphenyl)propionate] as an antioxidant was added, and again dry-blended using a tumbler blender to obtain a mixture. The obtained mixture was fed under a nitrogen atmosphere into a twin-screw extruder with a feeder. Further, liquid paraffin (kinetic viscosity at 37.78° C. of 7.59×10⁻⁵ m²/s) was injected into the extruder cylinder by a plunger pump. The operating conditions of the feeder and the pump were adjusted so that the ratio of liquid paraffin in the total mixture to be extruded was 65% by mass, namely, so that the polymer concentration (hereinafter sometimes abbreviated as “PC”) was 35% by mass.

Next, these materials were melt-kneaded while heating to 230° C. in the twin-screw extruder. The obtained melt-kneaded product was extruded via a T-die onto a cooling roll having a surface temperature controlled to 80° C., and the extruded product was brought into contact with the cooling roll, and molded (casted) to cool to solidify. Thus, a gel sheet, which is a sheet-like molded product, having a crude membrane thickness of 2,100 μm was obtained.

Then, the obtained gel sheet was guided to a simultaneous biaxial tenter, and stretched at 123° C. by a factor of 7.0 in the MD direction and 6.4 in the TD direction to obtain a stretched sheet.

Next, the obtained stretched film was guided to a methylene chloride bath, and thoroughly dipped in the methylene chloride to remove the liquid paraffin which is a plasticizer by extraction. Then, the methylene chloride was removed by drying.

Next, the stretched film to be subjected to heat setting (hereinafter sometimes abbreviated as “HS”) was guided to a TD tenter, where HS was carried out at a heat setting temperature of 133° C. and a stretching ratio of 1.6. Then, a relaxation operation was carried out at a relaxation ratio (HS relaxation ratio) of 0.8.

The physical properties of the obtained polyolefin microporous membrane were as follows: a membrane thickness of 20μ, a porosity of 40%, an air permeability of 270 seconds, an average pore size of 0.07μ, a tortuosity factor of 2.3, an MD strength of 150 MPa, and a TD strength of 130 MPa.

### <Base Membrane Hydrophilization Treatment>

A surfactant solution, which contains 80 parts by mass of a 40% by weight ethanol solution in water; 10 parts by mass of polyoxyethylene-modified polydimethylsiloxane (surfactant (A)) having a viscosity of 400 mm/s (25° C.), a specific gravity of 1.1, and a solubility in water of 5 g or more per 100 g of water; and 10 parts by mass of oleyl imidazoline (surfactant (B)) having the structure shown below and a solubility in water of 0.1 g or less per 100 g of water, was coated on the above base membrane using a gravure roll. The coated surfactant solution was then thermally dried at 60° C. to obtain a hydrophilic porous membrane to which 23% of surfactant was adhered based on the weight of the base membrane.

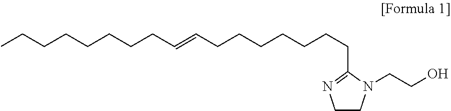 [SMILES: CCCCCCCC/C=C/CCCCCCCC1=NCCN1CCO]

### Examples 2 and 3

A hydrophilic membrane was obtained in the same manner as in Example 1, except that a polyolefin microporous membrane was used as the base membrane that was obtained under the production conditions shown in Table 1, in which the crude membrane thickness was adjusted so that the final membrane thickness was 20 μm.

### Example 4

A hydrophilic membrane was obtained in the same manner as in Example 1, except that a polyolefin microporous membrane was used as the base membrane that was obtained under the production conditions shown in Table 1, in which the stretching by the simultaneous biaxial tenter was carried out at 123° C. at a factor of 7.0 in the MD direction and 4.0 in the TD direction, and the crude membrane thickness was adjusted so that the final membrane thickness was 20 μm.

### Examples 5 and 6

A hydrophilic membrane was obtained in the same manner as in Example 1, except that the amount of the surfactant adhered was as shown in Table 1. The amount of the surfactant adhered was adjusted by the cell capacity on the gravure roll.

### Examples 7 and 8

A hydrophilic membrane was obtained in the same manner as in Example 1, except that the weight ratio of the surfactant was as shown in Table 1.

### Example 9

A hydrophilic membrane was obtained in the same manner as in Example 1, except that in the process for coating the surfactant solution with the gravure roll, the base membrane and a non-porous PET film having a thickness of 25 μm were laminated while continuously feeding so that the PET film was arranged on the face on the opposite side to the gravure roll, and that the PET film was peeled off after coating and drying.

### Example 10

A hydrophilic membrane was obtained in the same manner as in Example 1, except that polyoxyethylene alkyl ether having the structure shown below and a solubility in water of 5 g or more per 100 g of water was used as the surfactant (A).

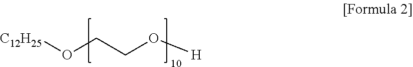

### Example 11

A hydrophilic membrane was obtained in the same manner as in Example 1, except that a polyolefin microporous membrane was used as the base membrane that was obtained under the production conditions shown in Table 1, in which the crude membrane thickness was adjusted so that the final membrane thickness was 20 μm.

### Example 12

Thirty-four parts by mass of a polymer mixture, which comprises 30% by mass of ultrahigh molecular weight polyethylene having an My of 2,000,000 and a density of 0.936 g/cm³, 40% by mass of linear low-density polyethylene having an My of 150,000 and a density of 0.926 g/cm³, and 30% by mass of copolymer polyethylene having an My of 120,000, a density of 0.954 g/cm³ and a propylene unit content of 1 mol %, was mixed and granulated with 45 parts by mass of DOP, 21 parts by mass of fine silica powder (product name: Nipsil LP, manufactured by Tosoh Silica Corporation), 0.3 parts by mass of BHT (dibutyl hydroxytoluene) as an antioxidant, and 0.3 parts by mass of DLTP (dilaurylthiodipropionate) with a Henschel mixer. The granules were then kneaded and extruded at 200° C. with a twin-screw extruder mounted with a T-die, and molded into a sheet-like form having a thickness of 100 μm with a calendar roll cooled to 150° C. The DOP was extracted from the molded product with methylene chloride, and the fine silica powder was extracted with sodium hydroxide, to obtain a microporous membrane wound in a draw ratio of 1.030 of the whole extraction process.

Two sheets of this microporous membrane were laminated on each other, and the laminate was stretched by a factor of 4.90 in the MD with a stretch roll heated to 120° C. HS was then carried out at a heat setting temperature of 129° C. and a stretch ratio of 2.0, and then a relaxation operation was carried out at a relaxation ratio (HS relaxation ratio) of 0.9.

### Comparative Example 1

A microporous membrane was obtained in the same manner as Example 1, except that a hydrophilization treatment with a surfactant was not carried out.

### Comparative Examples 2 and 3

A hydrophilic membrane was obtained in the same manner as in Example 1, except that a polyolefin microporous membrane was used as the base membrane that was obtained under the production conditions shown in Table 1, in which the crude membrane thickness was adjusted so that the final membrane thickness was 20 μm.

### Comparative Example 4

A hydrophilic membrane was obtained in the same manner as in Example 1, except that a polyolefin microporous membrane was used as the base membrane that was obtained under the production conditions shown in Table 1, in which the stretching by the simultaneous biaxial tenter was carried out at 115° C. at a factor of 5.0 in the MD direction and 5.0 in the TD direction, and the crude membrane thickness was adjusted so that the final membrane thickness was 20 μm.

### Comparative Example 5

A hydrophilic membrane was obtained in the same manner as in Example 1, except that only polyoxyethylene-modified polydimethylsiloxane (surfactant (A)) was used as a surfactant. The surfactant concentration in the surfactant solution was adjusted in the same manner as in Example 1.

### Comparative Example 6

A hydrophilic membrane was obtained in the same manner as in Example 1, except that only oleyl imidazoline (surfactant (B)) was used as a surfactant. The surfactant concentration in the surfactant solution was adjusted in the same manner as in Example 1.

### Comparative Example 7

A hydrophilic membrane was obtained in the same manner as in Example 5, except that only polyoxyethylene alkyl ether (surfactant (A)) was used as a surfactant. The surfactant concentration in the surfactant solution was adjusted in the same manner as in Example 1.

### Comparative Example 8

A hydrophilic membrane was obtained in the same manner as in Example 1, except that a monoaxially-stretched polyolefin microporous membrane produced by a dry method and having a tortuosity factor of 1.7 was used as the base membrane.

The results of an evaluation of the initial hydrophilic properties and the durable hydrophilic properties of the obtained microporous membranes are shown in Table 1.

TABLE 1

| | | | Ex- | Ex- | Ex- | Ex- | Ex- | Ex- | Ex- | Ex- | Ex- | Ex- |
|---|---|---|---|---|---|---|---|---|---|---|---|---|
| | | | ample | ample | ample | ample | ample | ample | ample | ample | ample | ample |
| | | | 1 | 2 | 3 | 4 | 5 | 6 | 7 | 8 | 9 | 10 |
| Base | Polymer | % | 35 | 35 | 35 | 35 | 35 | 35 | 35 | 35 | 35 | 35 |
| Membrane | Concentration | | | | | | | | | | | |
| Production | Heat setting | ° C. | 133 | 130 | 136 | 132 | 133 | 133 | 133 | 133 | 133 | 133 |
| Conditions | Temperature | | | | | | | | | | | |
| | Stretching Ratio | Factor | 1.6 | 1.6 | 1.7 | 1.5 | 1.6 | 1.6 | 1.6 | 1.6 | 1.6 | 1.6 |
| | Relaxation Ratio | Factor | 0.8 | 0.8 | 0.8 | 0.8 | 0.8 | 0.8 | 0.8 | 0.8 | 0.8 | 0.8 |
| Base | Membrane Thickness | μm | 20 | 20 | 20 | 20 | 20 | 20 | 20 | 20 | 20 | 20 |
| Membrane | Air Permeability | sec/100 cc | 270 | 240 | 500 | 270 | 270 | 270 | 270 | 270 | 270 | 270 |
| Physical | Porosity | % | 40 | 43 | 35 | 40 | 40 | 40 | 40 | 40 | 40 | 40 |
| Properties | Puncture strength | N | 6.0 | 5.8 | 8.0 | 5.5 | 6.0 | 6.0 | 6.0 | 6.0 | 6.0 | 6.0 |
| | MD Tensile Strength | MPa | 150 | 150 | 220 | 180 | 150 | 150 | 150 | 150 | 150 | 150 |
| | TD Tensile Strength | MPa | 130 | 110 | 200 | 50 | 130 | 130 | 130 | 130 | 130 | 130 |
| | MD/TD Tensile | — | 1.2 | 1.4 | 1.1 | 3.6 | 1.2 | 1.2 | 1.2 | 1.2 | 1.2 | 1.2 |
| | Strength Ratio | | | | | | | | | | | |
| | Average Pore Size | μm | 0.07 | 0.07 | 0.07 | 0.07 | 0.07 | 0.07 | 0.07 | 0.07 | 0.07 | 0.07 |
| | Tortuosity factor | — | 2.3 | 2.1 | 2.9 | 2.3 | 2.3 | 2.3 | 2.3 | 2.3 | 2.3 | 2.3 |
| Surfactant | Amount to be Adhered | wt % | 25 | 25 | 25 | 25 | 2 | 38 | 25 | 25 | 25 | 25 |
| | (vs. base membrane) | | | | | | | | | | | |
| | Surfactant (A) | (*) | a | a | a | a | a | a | a | a | a | c |
| | Surfactant (B) | (*) | b | b | b | b | b | b | b | b | b | b |
| | Mass Ratio (A/B) | — | 1.0 | 1.0 | 1.0 | 1.0 | 1.0 | 1.0 | 4.0 | 0.25 | 1.0 | 1.0 |
| Evaluation | Contact Angle Before | ° | <5 | <5 | <5 | <5 | 16 | <5 | <5 | 18 | <5 | 18 |
| | Dipping in Water | | | | | | | | | | | |
| | Contact Angle After | ° | 12 | 24 | <5 | 20 | 22 | 10 | 26 | 23 | 12 | 20 |
| | Dipping in Water | | | | | | | | | | | |
| | Electrical Resistance | Ω | 1.4 | 1.4 | 1.4 | 1.4 | 1.6 | 1.4 | 1.4 | 1.6 | 1.4 | 1.6 |
| | Electrical Resistance | Ω | 1.5 | 1.5 | 1.4 | 1.5 | 1.5 | 1.4 | 1.7 | 1.5 | 1.4 | 1.6 |
| | After Discharge | | | | | | | | | | | |
| | | | | | Compar- | Compar- | Compar- | Compar- | Compar- | Compar- | Compar- | Compar- |
| | | | Ex- | Ex- | ative | ative | ative | ative | ative | ative | ative | ative |
| | | | ample | ample | Example | Example | Example | Example | Example | Example | Example | Example |
| | | | 11 | 12 | 1 | 2 | 3 | 4 | 5 | 6 | 7 | 8 |
| Base | Polymer | % | 40 | — | 35 | 29 | 32 | 35 | 35 | 35 | 35 | — |
| Membrane | Concentration | | | | | | | | | | | |
| Production | Heat setting | ° C. | 128 | — | 133 | 122 | 124 | 123 | 133 | 133 | 133 | — |
| Conditions | Temperature | | | | | | | | | | | |
| | Stretching Ratio | Factor | 1.4 | — | 1.6 | 1.6 | 1.6 | 1.8 | 1.6 | 1.6 | 1.6 | — |
| | Relaxation Ratio | Factor | 0.8 | — | 0.8 | 0.8 | 0.8 | 0.8 | 0.8 | 0.8 | 0.8 | — |
| Base | Membrane Thickness | μm | 20 | 20 | 20 | 20 | 20 | 20 | 20 | 20 | 20 | 20 |
| Membrane | Air Permeability | sec/100 cc | 400 | 130 | 270 | 130 | 200 | 400 | 270 | 270 | 270 | 160 |
| Physical | Porosity | % | 40 | 47 | 40 | 53 | 47 | 50 | 40 | 40 | 40 | 55 |
| Properties | Puncture strength | N | 6.0 | 400 | 6.0 | 4.0 | 3.6 | 4.5 | 6.0 | 6.0 | 6.0 | 2.5 |
| | MD Tensile Strength | MPa | 150 | 230 | 150 | 130 | 100 | 120 | 150 | 150 | 150 | 110 |
| | TD Tensile Strength | MPa | 130 | 25 | 130 | 60 | 50 | 100 | 130 | 130 | 130 | 15 |
| | MD/TD Tensile | — | 1.2 | 9.2 | 1.2 | 2.2 | 2.0 | 1.2 | 1.2 | 1.2 | 1.2 | 7.3 |
| | Strength Ratio | | | | | | | | | | | |
| | Average Pore Size | μm | 0.05 | 0.11 | 0.07 | 0.06 | 0.06 | 0.03 | 0.07 | 0.07 | 0.07 | 0.05 |
| | Tortuosity factor | — | 2.3 | 2.1 | 2.3 | 1.6 | 1.9 | 1.9 | 2.3 | 2.3 | 2.3 | 1.7 |
| Surfactant | Amount to be Adhered | wt % | 25 | 25 | 0 | 25 | 25 | 25 | 25 | 25 | 25 | 25 |
| | (vs. base membrane) | | | | | | | | | | | |
| | Surfactant (A) | (*) | a | a | — | a | a | a | a | — | c | a |
| | Surfactant (B) | (*) | b | b | — | b | b | b | — | b | — | b |
| | Mass Ratio (A/B) | — | 1.0 | 1.0 | — | 1.0 | 1.0 | 1.0 | — | — | — | 1.0 |
| Evaluation | Contact Angle Before | ° | <5 | <5 | 115 | <5 | <5 | <5 | <5 | 42 | 18 | <5 |
| | Dipping in Water | | | | | | | | | | | |
| | Contact Angle After | ° | 10 | 28 | 115 | 52 | 49 | 42 | 80 | 55 | 100 | 62 |
| | Dipping in Water | | | | | | | | | | | |
| | Electrical Resistance | Ω | 1.6 | 1.2 | >5 | 1.5 | 1.5 | 1.9 | 1.4 | 2.0 | 1.6 | 1.6 |
| | Electrical Resistance | Ω | 1.7 | 1.4 | >5 | 2.2 | 2.1 | 2.7 | 4.2 | 2.2 | >5 | 2.5 |
| | After Discharge | | | | | | | | | | | |

(*) a: Polyoxyethylene-Modified Polydimethylsiloxane
b: Oleyl Imidazoline
c: Polyoxyethylene Alkyl Ether

The hydrophilic membrane according to the present embodiment illustrated in the above Examples has an excellent balance between initial hydrophilic properties and durable hydrophilic properties and is suitable as an aqueous electrolyte battery separator.

Further, when the adhered surfactant was removed from the hydrophilic membrane illustrated in the Examples by heat-treating for 6 hours at 50° C. in chloroform and then leaving for two days at ordinary temperature, the physical properties of the base membrane were about the same as those of the membrane before adhering the surfactant.

This application claims the benefit of a Japanese patent application filed in the Japan Patent Office on Sep. 26, 2011 (Japanese Patent Application No. 2011-209561), the entire contents of which are incorporated herein by reference.

### INDUSTRIAL APPLICABILITY

According to the present invention, provided is a microporous membrane that has an excellent balance between initial hydrophilic properties and durable hydrophilic properties and is suitable as an aqueous electrolyte battery separator.

1: A microporous membrane comprising a polyolefin microporous membrane and a surfactant adhering to the polyolefin microporous membrane, wherein
the surfactant comprises a surfactant (A) having a solubility in 100 g of water of 5 g or more and a surfactant (B) having a solubility in 100 g of water of less than 0.1 g,
the surfactants (A) and (B) are adhered in an amount of 1 to 40% by mass in total based on 100% by mass of the polyolefin microporous membrane, and
the polyolefin microporous membrane has a tortuosity factor of more than 2.0.

2: The microporous membrane according to claim 1, wherein the polyolefin microporous membrane has an average pore size of 0.06 to 0.10 μm.

3: The microporous membrane according to claim 1, wherein a ratio (MD/TD) between an MD tensile strength and a TD tensile strength of the polyolefin microporous membrane is 0.3 to 3.0.

4: The microporous membrane according to claim 1, wherein a mass ratio (A/B) between the surfactant (A) and the surfactant (B) is 0.3 to 3.0.

5: A battery separator, wherein the microporous membrane according to claim 1 is used.

6: An aqueous electrolyte battery comprising the battery separator according to claim 5, a positive electrode, a negative electrode, and an electrolyte.

7: A method for producing the microporous membrane according to claim 1, comprising the steps of:
coating a surfactant solution on at least one face of a polyolefin microporous membrane with a gravure roll; and
removing a solvent from the surfactant solution coated on the polyolefin microporous membrane by drying.

8: A method for producing the microporous membrane according to claim 1, comprising the steps of:
laminating a non-porous polymer film on one face of a polyolefin microporous membrane;
coating a surfactant solution on an opposite face to a laminated face of the polyolefin microporous membrane on which the non-porous polymer film has been laminated;
removing a solvent from the surfactant solution coated on the polyolefin microporous membrane by drying; and
peeling the non-porous polymer film from the polyolefin microporous membrane.

9: A microporous membrane in which a surfactant is adhered to a polyolefin microporous membrane, wherein a contact angle with respect to water after dipping in water for 24 hours and then drying is 30° or less.
